(19) United States
(12) Patent Application Publication
(10) Pub. No.: US 2026/0168433 A1
(43) Pub. Date: Jun. 18, 2026

(54) INTERNAL COMBUSTION ENGINE HAVING A FLOW THAT IS ABLE TO BE SHUT OFF FOR INCREASING TORQUE

(71) Applicant: MAN Truck & Bus SE, München (DE)

(72) Inventors: Thomas Malischewski, München (DE); Martin ZUNDEL, München (DE); Dominic Hyna, Fürth (DE)

(73) Assignee: MAN Truck & Bus SE, München (DE)

(21) Appl. No.: 19/424,812

(22) Filed: Dec. 18, 2025

(30) Foreign Application Priority Data
Dec. 18, 2024 (DE) 10 2024 004 298.9

(51) Int. Cl. F02B 37/16; F02B 37/10; F02B 37/18

(52) U.S. Cl. CPC F02B 37/16; F02B 37/10; F02B 37/183; F05D 2260/606

(57) ABSTRACT

The invention relates to an internal combustion engine (100). The internal combustion engine (100) has a turbocharger device (10) which has a turbine (12) and a compressor (14) operatively connected to the turbine (12), wherein the turbine (12) has a first flow (12a) and a second flow (12b). The internal combustion engine (100) also has an exhaust gas manifold (20), which fluidically connects together the first flow (12a) and the second flow (12b) with a plurality of cylinders (2) of the internal combustion engine (100). Furthermore, the internal combustion engine (100) has an exhaust gas conduit (30), by means of which a first exhaust gas stream through the first flow (12a) is settable independently of a second exhaust gas stream through the second flow (12b). Finally, the internal combustion engine (100) has a bypass line (40), which the air compressed by the compressor (14) is able to be fed to the turbine (12), bypassing the plurality of cylinders (2).

The invention relates to an internal combustion engine and also to a watercraft and to a motor vehicle, each having such an internal combustion engine, and also to a method for operating the internal combustion engine.

The operation of ships' engines generally requires a sufficiently high torque over the entire speed range for acceleration. This usually requires the availability of a sufficient torque even at speeds of below 1300 rpm.

An increase in the nominal output of ships' engines generally results in the use of a larger propeller. However, as a result, the output requirement increases not only in nominal operation but also in the lower speed range (for example below 1300 rpm). This means that, with an increasing output, the range of the maximum torque also needs to be greater. This has the result that the compressor is operated from the surge line to the choke line. Accordingly, there is a demand to maximize the spread between the surge line and choke line.

Previous approaches for making it possible to operate the ship's engine in a speed band that is as wide as possible have often been based on multistage charging, in which, for example, two turbochargers are connected in series. Furthermore, it is possible to bypass the surge line in the lower speed range by way of electrically or mechanically driven auxiliary compressors. Both variants are structurally complex and also very expensive, however.

The use of VTG exhaust gas turbochargers with a variable turbine geometry has also proven likewise not to be practicable on account of the salty environment, on account of slag deposits during heavy fuel operation and on account of the often long service lives in the case of watercraft and the associated susceptibility to wear.

The invention addresses the problem of providing an improved possibility that makes it possible to operate an internal combustion engine in as wide a speed band as possible with sufficient torque. The invention preferably addresses the problem of providing a simple and robust possibility, by means of which an increase in output of an internal combustion engine is allowed compared with previous solutions, in particular in a speed range below 1300 rpm.

These problems can be solved by the features of the independent claims. Advantageous embodiments and applications of the invention are the subject of the dependent claims and are explained in more detail in the following description with partial reference to the figures.

A first independent aspect of the present disclosure relates to a (for example multi-cylinder) internal combustion engine. By way of example, the internal combustion engine may be a diesel and/or four-stroke internal combustion engine. Preferably, the internal combustion engine is an internal combustion engine for a watercraft (for example a ship).

The internal combustion engine has a (for example exhaust gas) turbocharger device, which has a (for example exhaust gas) turbine (for example a radial turbine) and a (for example fresh air) compressor (for example a radial compressor) operatively coupled to the turbine. Accordingly, the internal combustion engine can be a supercharged and/or superchargeable internal combustion engine. The turbine in this case has a first flow and a second flow. By way of example, the turbine can be a double-flow turbine.

The internal combustion engine also has a (for example single-flow) exhaust gas manifold (for example an outlet manifold). The exhaust gas manifold fluidically connects together the first flow and the second flow of the turbine with a plurality of cylinders of the internal combustion engine. By way of example, exhaust gases from the plurality of cylinders can be collected via the exhaust gas manifold and be able to be fed to the first and second flow.

The internal combustion engine also has an exhaust gas conduit (for example having a flap mechanism). Preferably, by means of the exhaust gas conduit, a first exhaust gas stream through the first flow is settable independently of a second exhaust gas stream through the second flow. By way of example, by means of the exhaust gas conduit, a quantity of exhaust gas fed respectively to the first and the second flow can be variable. Particularly preferably, by means of the exhaust gas conduit, the first exhaust gas stream is settable independently of the second exhaust gas stream such that, by means of the exhaust gas conduit, the first exhaust gas stream is (for example only or specifically) able to be throttled or blocked, for example in order, as a result, to increase a flow rate of the second exhaust gas stream (and thus an output of the turbocharger device).

The internal combustion engine also has a bypass line (for example a bypass pipeline and/or bypass hose line) (which is, for example, able to be shut off). Via the bypass line, (for example fresh) air compressed by the compressor (for example a part of the air compressed by the compressor) is preferably able to be fed to the turbine, preferably to the first flow thereof (for example only to the first flow thereof)—bypassing the plurality of cylinders. By way of example, the bypass line can lead (for example only) into the first flow and/or into a portion of the exhaust gas manifold that is associated with the first flow. Via the bypass line, it is possible to create an additional mass flow or air stream to the turbine, in particular into the first flow throttled or blocked by means of the exhaust gas conduit. Preferably, the bypass line serves to realize a stable operating point of the turbocharger device below a surge line of the turbocharger device.

Overall, as a result, an internal combustion engine is provided which advantageously makes it possible, at low performance levels, for example in a speed range of the internal combustion engine below 1300 rpm, to increase the flow rate of the exhaust gas stream in the second flow and thus the output of the turbocharger device by throttling or blocking the first flow. The bypass line in this case advantageously prevents the turbine from passing to the surge line, and also makes it easier for the compressor to accelerate. Compared with concepts with multistage supercharging or auxiliary compressors, the proposed solution can be realized in a structurally simpler and more space-saving manner, and is suitable, on account of its reliability and robustness, in particular for use in watercraft.

According to a first aspect, each of the plurality of cylinders may be fluidically connected and/or able to be fluidically connected both to the first flow and to the second flow via the exhaust gas manifold. Preferably, the (for example single-flow) exhaust gas manifold fluidically connects all the cylinders of the internal combustion engine both to the first flow and to the second flow, preferably such that exhaust gas from each cylinder of the internal combustion engine can flow to the first and second flow.

In addition or alternatively, the exhaust gas manifold may be designed to combine exhaust gases from all of the plurality of cylinders and to feed the combined exhaust gases to the first and second flow. By way of example, the exhaust gas manifold may have a plurality of exhaust gas manifold inputs, which are each fluidically connected to an output of each of the plurality of cylinders, and a common exhaust gas manifold output, which is fluidically connected to an input of the first flow (for example a first flow inlet) and an input of the second flow (for example a second flow inlet).

According to a further aspect, the exhaust gas conduit may have a (for example only one) shut-off element for throttling and/or blocking the first exhaust gas stream. By way of example, the shut-off element may have a flap, a slide and/or a valve and/or be in the form of a flap, a slide and/or a valve. Only by way of example, the shut-off element may be a modified dynamic pressure flap of an engine brake of the internal combustion engine. Preferably, the shut-off element is arranged in the first flow or upstream of the first flow (for example directly at or in front of an inlet of the first flow). Advantageously, appropriate throttling or blocking of the first exhaust gas stream can be achieved in a particularly simple manner as a result.

In one embodiment, it is possible for the exhaust gas conduit not to have any further shut-off elements (for example further flaps, slides and/or valve). Preferably, the exhaust gas conduit thus has only the abovementioned shut-off element. In addition or alternatively, it is possible for the second exhaust gas stream not to be able to be throttled or blocked by means of a further shut-off element. Advantageously, particularly simple throttling or blocking of the first exhaust gas stream can likewise be achieved as a result.

In another embodiment, the exhaust gas conduit may have a further shut-off element for throttling and/or blocking the second exhaust gas stream. By way of example, the further shut-off element may have a flap, a slide and/or a valve and/or be in the form of a flap, a slide and/or a valve. Preferably, the further shut-off element is arranged in the second flow or upstream of the second flow (for example directly at or in front of an inlet of the second flow). Accordingly, it is respectively possible for the first exhaust gas stream to be able to be throttled and/or blocked via the shut-off element, also able to be referred to as the “first” shut-off element, and for the second exhaust gas stream to be able to be throttled and/or blocked via the further shut-off element, also able to be referred to as the “second” shut-off element. Preferably, the (first) shut-off element and the further (or second) shut-off element are able to be actuated independently of one another. By way of example, selectively only the first or the second exhaust gas stream may be able to be throttled and/or blocked via the respective shut-off element. Advantageously, the setting possibilities of the exhaust gas conduit can be increased as a result.

According to a further aspect, the bypass line has (for example at a first end of the bypass line) a bypass inlet (for example a pipe and/or hose opening), wherein the bypass inlet may be fluidically connected (for example directly) to the compressor or (for example directly) to a charge air line, arranged upstream of the compressor, of the internal combustion engine. By way of example, the bypass inlet may be fluidically connected (for example directly) to a region of the charge air line between the compressor and an intercooler of the internal combustion engine. Via the bypass inlet, the bypass line can thus lead, by way of example, (for example directly) into the compressor or (for example directly) into the charge air line. In addition or alternatively, the bypass line may have (for example at an opposite second end of the bypass line from the first end) a bypass outlet (for example a pipe and/or hose outlet), wherein the bypass outlet may be fluidically connected (for example directly) to the first flow or (for example directly) to a portion of the exhaust gas manifold that is associated with the first flow (for example to a branch portion of the exhaust gas manifold that is associated with the first flow). Preferably, the bypass outlet is fluidically connected, downstream of the exhaust gas conduit, for example downstream of the shut-off element, (for example directly) to the first flow or (for example directly) to the portion of the exhaust gas manifold that is associated with the first flow. By way of example, the bypass outlet may lead, downstream of the exhaust gas manifold and upstream of a turbine wheel of the turbine, (for example directly) into the first flow or (for example directly) into the portion of the exhaust gas manifold that is associated with the first flow. Advantageously, a reliable air feed to the turbine can be ensured as a result.

According to a further aspect, the bypass line may be configured and/or arranged so as to introduce air (or a part of the air) compressed by the compressor only (for example directly) into the first exhaust gas stream. By way of example, the bypass line may be configured to feed air (or a part of the air) compressed by the compressor only (for example directly) into the first flow or (for example directly) into a portion of the exhaust gas manifold that is associated with the first flow. Preferably, the bypass line thus does not lead (for example upstream of the turbine wheel of the turbine) (directly) into the second flow and/or the second exhaust gas stream. Advantageously, a particularly stable operating point of the turbocharger device can be achieved as a result.

In addition or alternatively, the bypass line may be configured and/or arranged so as to feed air compressed by the compressor to the turbine downstream of the exhaust gas conduit and upstream of a turbine wheel of the turbine (for example to the first flow and/or to the portion of the exhaust gas manifold that is associated with the first flow). On account of the significant pressure drop (more boost pressure than counter pressure), an additional flow can advantageously be provided in this way without significant additional effort.

In addition or alternatively, it is also possible for air compressed by the compressor to be able to be fed to the first flow (or to the portion of the exhaust gas manifold that is associated with the first flow) via the bypass line when the first exhaust gas stream has been throttled or blocked by means of the exhaust gas conduit. Preferably, the air feed via the bypass line thus takes place downstream of the exhaust gas conduit (for example downstream of the shut-off element thereof). The pressure drop can also be used advantageously here.

According to a further aspect, air may be able to flow through the bypass line only in the direction of the turbine (and, for example, not the other way). By way of example, it may be possible for flow to take place through the bypass line only along a main direction of flow, wherein the latter extends preferably from the compressor to the turbine. In addition or alternatively, the bypass line may have a non-return element (for example a non-return valve and/or a check valve). Preferably, the non-return element is arranged and/or configured such that air is able to flow through the bypass line only in the direction of the turbine. Advantageously, it is possible, as a result, to prevent exhaust gas from flowing to the compressor side when the two flows are open and the exhaust gas counter pressure is greater than the boost pressure (negative pressure difference).

According to a further aspect, the bypass line may have an actuator (a control and/or regulating valve), by means of which preferably an air flow through the bypass line is able to be set (for example actively). The actuator may be settable, for example, only selectively in the settings “open” or (for example completely) “closed”. Preferably, however, the actuator additionally has further settings. By way of example, the actuator may be transferable continuously or in several steps between an open setting and a closed setting. Advantageously, the additional mass flow can, as a result, be set as far as possible as required.

According to a further aspect, the internal combustion engine may also have a control device (for example a control unit). The control device may have, for example, a processor and a memory, in which commands that are processable by the processor are stored.

According to a further aspect, the control device may be designed (for example configured) (for example in a partial-load operating mode) to control the exhaust gas conduit (for example the shut-off element thereof) to set (for example throttle or block) the first exhaust gas stream and/or the second exhaust gas stream (for example automatically), preferably depending on a speed, an engine load and/or an exhaust gas volumetric flow of the internal combustion engine. By way of example, the control device may be designed to output control commands to the exhaust gas conduit which bring about, for example, an adjustment of the exhaust gas conduit. The control device and the exhaust gas conduit may, in this case, be connected for example via one or more signal lines.

In one embodiment, the control device may be designed (for example configured) (for example in a or the partial-load operating mode), when a predetermined (for example previously stored) trigger condition exists (for example if a speed of the internal combustion engine drops below a speed boundary value, for example below 1200 rpm), to control the exhaust gas conduit (for example the shut-off element thereof) in such a way that the first exhaust gas stream through the first flow is throttled or blocked, such that, preferably, the second exhaust gas stream through the second flow is increased (for example at the same time). In this case, the control device may be designed to receive sensor data (for example speed data, engine load data and/or exhaust gas volume data) from one or more sensors (for example engine and/or vehicle sensors) and to determine the existence or non-existence of the trigger condition on the basis of the received sensor data. Preferably, the control device is also designed, when the predetermined trigger condition no longer exists (for example if the speed of the internal combustion engine rises (back) above the speed boundary value, for example above 1200 rpm), to control the exhaust gas conduit in such a way that the first exhaust gas stream through the first flow is not throttled or blocked. Advantageously, the output of the turbine can be considerably increased at low performance levels as a result.

The speed boundary value may be, for example, 1300 rpm, preferably 1200 rpm, particularly preferably 1100 rpm.

In addition or alternatively, the control device may be designed (for example configured) to control the actuator to set the air flow through the bypass line (for example in a manner adapted to the exhaust gas conduit or independently of the exhaust gas conduit), preferably depending on a speed, an engine load and/or an exhaust gas volumetric flow of the internal combustion engine. By way of example, the control device may be designed (for example in the partial-load operating mode) to enable the air flow through the bypass line when the predetermined trigger condition exists (for example if the speed of the internal combustion engine drops below the speed boundary value, for example below 1200 rpm) and/or to throttle and/or block the air flow through the bypass line if the trigger condition does not exist.

According to a further aspect, the turbine may be a double-flow turbine. By way of example, the turbine may have only the (abovementioned) first flow and the (abovementioned) second flow.

In addition or alternatively, the turbine may have no further flows apart from the first and second flow. Preferably, the turbine is thus not a triple- or multi-flow turbine.

In addition or alternatively, the exhaust gas manifold may be a single-flow exhaust gas manifold. By way of example, the exhaust gas manifold may have a plurality of manifold inlets, which are each fluidically connected to valve outlets of the internal combustion engine, and a common manifold outlet, which is fluidically connected to the turbine.

In addition or alternatively, the exhaust gas manifold may fluidically connect all the cylinders of the internal combustion engine both to the first flow and to the second flow. By way of example, the “plurality of cylinders” may be all the cylinders of the internal combustion engine.

In addition or alternatively, the internal combustion engine may have an intercooler for cooling the air compressed by the compressor. By way of example, the intercooler may be arranged in a charge air line that connects the compressor to the plurality of cylinders, for example downstream of the compressor and upstream of the plurality of cylinders.

A further independent aspect of the present disclosure relates to a watercraft (for example a boat or ship) having an internal combustion engine as described herein. Consequently, the features disclosed above in connection with the internal combustion engine are also intended to be disclosed and able to be claimed in connection with the watercraft. The same is intended to also apply conversely. The watercraft may in this case have, for example, a propeller, which is operatively connected to the internal combustion engine.

Although the internal combustion engine described herein is particularly suitable for use in watercraft, the use of the internal combustion engine is not limited thereto. A further independent aspect of the present disclosure therefore relates to a land vehicle or motor vehicle, preferably a commercial vehicle, having an internal combustion engine as described herein. Here too, the features disclosed above in connection with the internal combustion engine are also intended to be disclosed and able to be claimed in connection with the motor vehicle. The same is intended to also apply conversely.

A further independent aspect of the present disclosure relates to a method for operating an internal combustion engine as described herein. Here too, the features disclosed above in connection with the internal combustion engine are also intended to be disclosed and able to be claimed in connection with the method. The same is intended to also apply conversely.

The method has (for example in a partial-load operating mode and/or if a predetermined trigger condition exists, for example if a speed of the internal combustion engine drops below a speed boundary value, for example 1200 rpm) the following steps:
combining (for example collecting) exhaust gas from a plurality of cylinders of the internal combustion engine, for example by means of a (for example single-flow) exhaust gas manifold (for example an outlet manifold).
feeding the combined (for example collected) exhaust gases (for example via the exhaust gas manifold) to a first flow and to a second flow of a (for example exhaust gas) turbine (for example a radial turbine) of a (for example exhaust gas) turbocharger device of the internal combustion engine. In this case, one part of the (previously) combined exhaust gases flows as a first exhaust gas stream through the first flow and another part of the (previously) combined exhaust gases flows as a second exhaust gas stream through the second flow. Preferably, the turbine is operatively coupled, for example via a shaft, to a (for example fresh air) compressor (for example a radial compressor) of the turbocharger device.
setting (for example throttling or blocking) the first exhaust gas stream through the first flow, for example by means of an exhaust gas conduit, independently of the second exhaust gas stream through the second flow, preferably such that, as a result, a flow rate of the second exhaust gas stream (and thus an output of the turbocharger device) is increased. By way of example, to this end, a shut-off element (for example a flap, a slide and/or a valve) of the exhaust gas conduit can be closed or shut off. Preferably, the setting takes place such that more exhaust gas flows through the second flow than through the first flow.
feeding air compressed, for example, by means of a or the compressor of the turbocharger device to the turbine (for example to the first flow), for example via a bypass line, bypassing the plurality of cylinders, preferably in order, as a result, to realize a stable operating point of the turbocharger device below a surge line of the turbocharger device. Preferably, the compressed air is fed directly and/or only into the first flow, preferably downstream of (or after) the exhaust gas conduit or the shut-off element.

In general, the term “downstream” can be understood as meaning “downwardly along the stream” and/or “in the direction away from the source of the stream”. Accordingly, the term “upstream” can be understood as meaning “upwardly along the stream” or “in the direction of the source of the stream”. In the region of the exhaust tract, the stream relates to the cylinders as source. The stream or the exhaust gas thus flows from the cylinders through the exhaust gas manifold to the turbine, while in the fresh air tract, the stream or the fresh air flows from the environment as the source (through the compressor) to the cylinders of the internal combustion engine.

The above-described embodiments and features are able to be combined with one another as desired. Further details and advantages will be described in the following text with reference to the appended drawings, in which

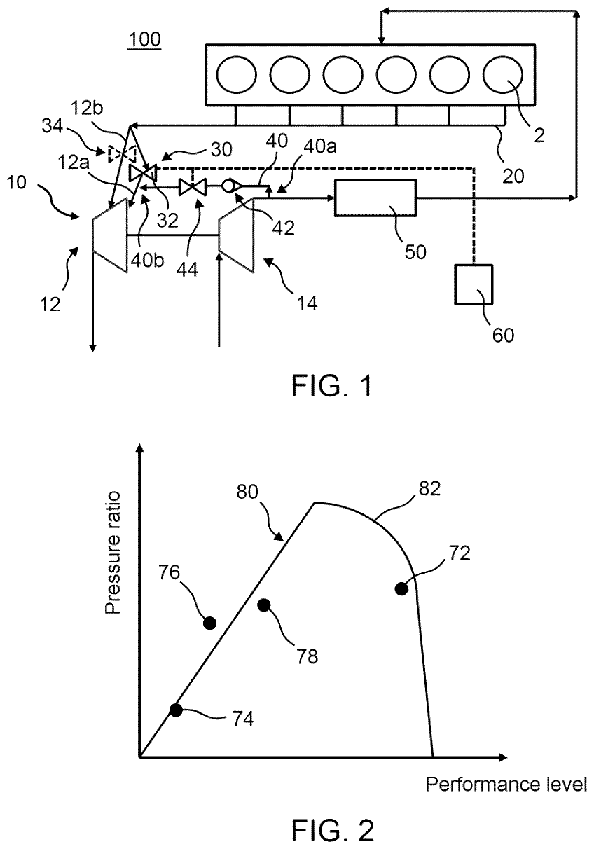

FIG. 1: shows a schematic illustration of an internal combustion engine according to one embodiment, and

FIG. 2: shows a schematic compressor characteristic diagram of a compressor according to one embodiment.

The embodiments illustrated in the figures at least partially correspond to one another, and so similar or identical parts are provided with the same reference signs and, for the explanation thereof, reference is also made to the description of the other embodiments or figures, in order to avoid repetitions.

FIG. 1 shows an internal combustion engine 100. The internal combustion engine 100 is, merely by way of example, a superchargeable diesel internal combustion engine. The internal combustion engine 100 can be comprised in a watercraft (not illustrated), for example a ship.

By way of example, the internal combustion engine 100 can serve for the propulsion of the watercraft and be operatively coupled to a propeller of the watercraft. In principle, however, the internal combustion engine 100 can also be installed in a motor vehicle (not illustrated).

The internal combustion engine 100 may have a plurality of, in the present case for example six, cylinders 2. The cylinders 2 may be arranged in a manner spaced apart from one another along a longitudinal direction. In each of the cylinders 2, a reciprocating piston (not illustrated) connected to a crankshaft (not illustrated) of the internal combustion engine 100 may be accommodated. A combustion cycle of each cylinder 2 may comprise four strokes: an intake stroke, a compression stroke, an expansion stroke and an exhaust stroke.

At least one inlet valve and at least one outlet valve may be associated with each of the cylinders 2 (this not being illustrated). The inlet and outlet valve may be able to be actuated by means of a conventional (for example variable) valve train, which is not shown in more detail in the figures.

The internal combustion engine 100 may have an exhaust tract with an exhaust gas manifold 20. The exhaust gas manifold 20 may be fluidically connected to the outlet valves. The exhaust gas manifold 20 may be designed to combine the exhaust gas coming from the outlet valves and to conduct it to a turbocharger device 10. It is also possible for pressure shocks from the respective cylinders 2 to be dissipated in the exhaust gas manifold 20 and for the turbocharger device 10 thus to be provided with exhaust gas at a substantially constant pressure. The exhaust gas manifold 10 may, as illustrated in FIG. 1, be configured in a single-flow manner. Accordingly, the exhaust gas from all the cylinders 2 can be combined in a single or joint exhaust gas manifold and fed to the turbocharger device 10.

The turbocharger device 10 may, in a manner known per se, having a turbine 12 and a compressor 14 operatively coupled to the turbine 12, for example via a shaft. The turbocharger device 10 may be configured to use a part of the energy from the engine exhaust gas by means of a turbine 12 and a compressor 14 in order to allow a greater air quantity to flow into the cylinders 2. To this end, the collected or combined exhaust gas may be able to be fed to the turbine 12 via the exhaust gas manifold 20. The turbine 12 may have a, for example rotatably mounted, turbine wheel. The turbine wheel may be surrounded by a turbine housing and/or be received in a turbine wheel chamber of the turbine housing. As a result of the exhaust gas flowing against the turbine wheel, the turbine wheel may be able to be set in rotation in a manner known per se, this being transmissible to the compressor 14, for example via the shaft, in order to drive a compressor wheel of the compressor 14. The compressor 14 that is thus able to be driven by the turbine 12 may be configured to compress (atmospheric) fresh air and to feed it to the cylinders 2 of the internal combustion engine 100 via a charge air line along the arrows shown in the figures. On the route between the compressor 14 of the turbocharger device 10 and the cylinders 2, it is also possible for an intercooler 50 to be arranged, in order to cool the compressed fresh air or charge air.

The present internal combustion engine 100 is characterized in that the turbine 12 has a first flow 12a and a second flow 12b. By way of example, the turbine 12 may be a double-flow turbine, as illustrated in FIG. 1. The first flow 12a and the second flow 12b may be separated from one another by a partition wall (for example of the turbine housing) and/or extend parallel to one another. Via the first flow 12b, a first flow inlet of the turbine 12 may be fluidically connected to a flow outlet that leads into the turbine wheel chamber. Likewise, via the second flow 12b, a second flow inlet of the turbine 12 may be fluidically connected to a second flow outlet that likewise leads into the turbine wheel chamber. Preferably, the first flow inlet and the second flow inlet are separated from one another. In addition or alternatively, it is also possible for the first flow outlet and the second flow outlet to be separated from one another. The first and/or second flow outlet may be in the form of a nozzle.

The first flow 12a and the second flow 12b may be arranged parallel to one another. In the first flow 12a, a first exhaust gas stream may be able to be conducted. In the second flow 12b, a second exhaust gas stream may be able to be conducted. Preferably, the first and the second exhaust gas stream are fluidically separated from one another in the region between the turbine wheel chamber and the respective flow inlets. The first exhaust gas stream may be associated, via the first flow outlet, with a first turbine half of the turbine wheel. Accordingly, the second exhaust gas stream may be associated, via the second flow outlet, with another turbine half of the turbine wheel.

Via the exhaust gas manifold 20, a plurality, in the present case for example all, of the cylinders 2 of the internal combustion engine 100 are in this case fluidically connected both to the first flow 12a and to the second flow 12b. Preferably, each of the plurality of cylinders 2 is fluidically connected both to the first flow 12a and to the second flow 12b via the exhaust gas manifold 20. By way of example, the exhaust gas manifold 20 may be configured to combine exhaust gases from all of the plurality of cylinders 2 and to feed the combined exhaust gases (for example at the same time) to the first flow inlet and to the second flow inlet. In this case, the first and second flow inlet may be connected in parallel, for example via a corresponding flange connection, to a common manifold outlet of the exhaust gas manifold 20. Alternatively, an end, facing the turbine 12, of the exhaust gas manifold 20 may also branch into two portions. Each of these portions may be associated with one of the two flows and/or have a respective manifold outlet, wherein preferably one of the manifold outlets is fluidically connected to the first flow inlet and the other of the manifold outlets is fluidically connected to the second flow inlet.

The internal combustion engine 100 also has an exhaust gas conduit 30, by means of which a first exhaust gas stream through the first flow 12a is settable independently of a second exhaust gas stream through the second flow 12a. By way of example, the exhaust gas conduit may, to this end, as illustrated in FIG. 1, have a shut-off element 32, for example a shut-off valve, for throttling and/or blocking the first exhaust gas stream. The shut-off element 32 may be arranged in the first flow 12a or upstream of the first flow 12a, for example upstream of the first flow inlet in the portion of the exhaust gas manifold 20 that is associated with the first flow 12a. In the embodiment illustrated in FIG. 1, the second flow 12b is not able to be throttled or blocked. By way of example, only the first exhaust gas stream may be able to be throttled or blocked by means of the exhaust gas conduit 30 or by means of the first shut-off element 32. In principle, the exhaust gas conduit 30 may, however, also have an (optional) further shut-off element 34 for throttling and/or blocking the second exhaust gas stream. Preferably, the shut-off element 32 is in this case able to be actuated independently of the further shut-off element 34.

The exhaust gas conduit 30, in particular the shut-off element 32 thereof, may be settable via a control device 60 of the internal combustion engine 100. By way of example, the control device 60 and the exhaust gas conduit 30 or the shut-off element 32 thereof may be connected via a signal line (dashed line). By controlling the exhaust gas conduit 30 or the shut-off element 32 thereof, it is thus possible for the first exhaust gas stream to be able to be throttled or blocked-independently of the second exhaust gas stream through the second flow 12a.

Preferably, the exhaust gas conduit 30 is controlled automatically in this case, for example depending on a speed (for example sensed by sensors), an engine load and/or an exhaust gas volumetric flow of the internal combustion engine 100.

By way of example, the control device 60 may be designed to control the exhaust gas conduit in such a way that, in a (lower) speed range of between 600 and 1200 rpm, only the first exhaust gas stream is blocked or disabled, for example by shutting off and/or closing the shut-off element 32. Preferably, as a result, more exhaust gas is fed to the second flow 12b, with the result that a flow rate of the second exhaust gas stream is increased therein. As a result, advantageously, the output of the turbine 12 can be markedly increased at low performance levels, this being discussed again in detail in connection with FIG. 2. If the speed of the internal combustion engine 100 increases to above 1200 rpm, the control device 60 may also be designed to control the exhaust gas conduit 30 in such a way that the first flow is unblocked or the shut-off element 32 is opened. Besides the above-described control on the basis of the speed, it is also possible, in addition or alternatively, for further operating parameters, for example an engine load and/or an exhaust gas volumetric flow, to be taken into consideration.

Without further additional measures, however, the risk would arise that the compressor 14 could lie outside the surge line at low speeds, and this could counter reliable operation. In order to shift the operating point into the regular working range, provision is therefore made to create an additional mass flow. This could take place, in principle, via a corresponding design of the camshaft, since, with a blocked shut-off element 32 but generally a higher exhaust gas counter pressure prevails than boost pressure, a camshaft approach is not considered.

Instead, the internal combustion engine 100 also has a bypass line 40, via which air compressed by the compressor 14 is able to be fed to the turbine 12, bypassing the plurality of cylinders 2. By way of example, the bypass line 40 may have a (only one) bypass inlet 40a and a (only one) bypass outlet 40b. The bypass inlet 40a and the bypass outlet 40b may be connected together via a pipe and/or hose line.

The bypass inlet 40a may be fluidically connected directly to the compressor 14 or to the charge air line. By way of example, the bypass inlet 40a, as illustrated in FIG. 1, may be fluidically connected to a region of the charge air line between the compressor 14 and the intercooler 50, i.e. a region of the charge air line upstream of the compressor 14 and downstream of the intercooler 50. It is thus possible for a part of the air compressed by the compressor 14 to flow into the bypass inlet 40a.

The bypass outlet 40b may be fluidically connected directly to the first flow 12a or to the portion of the exhaust gas manifold 20 that is associated with the first flow 12a. By way of example, the bypass outlet 40b may lead, downstream of the shut-off element 32, into the first flow or into the portion of the exhaust gas manifold 20 that is associated with the first flow 12a. Accordingly, the bypass line 40 may be arranged such that air compressed by the compressor 14 is able to be fed to the first flow 12a even when the first exhaust gas stream is blocked by means of the exhaust gas conduit 30 or by means of the shut-off element 32. In other words, the bypass line 40 can pass from downstream of the compressor 14 after the shut-off element 32 to the closed (first) flow in the turbine 12. Advantageously, as a result, a stable operating point of the turbocharger device 10 below a surge line of the turbocharger device 10 can be realized, this being discussed again in more detail later in connection with FIG. 2.

In order to prevent exhaust gas from flowing onto the compressor side when the first and second flow 12a and 12b are open and the exhaust gas counter pressure is greater than the boost pressure (negative pressure difference), the bypass line 40 also has a non-return element 42. By way of example, the non-return element 42 may be in the form of a non-return valve and/or check valve. Preferably, the non-return element 42 allows flow to pass through the bypass line 40 only in the direction of the turbine 12 and/or blocks flow through the bypass line 40 in the direction of the compressor 14.

In order for the additional mass flow through the bypass line 40 to be controlled as far as possible as required, the latter may also have an actuator 44, by means of which an air flow through the bypass line 40 is settable. By way of example, the bypass line 40 may be able to be shut off (fully or in both directions) via the actuator 44. The actuator 44 may be in the form, for example, of a control and/or regulating valve. The actuator 44 may be (actively) adjustable via the control device 60. By way of example, the control device 60 may also be designed to control the actuator 44 to set the air flow through the bypass line 40, preferably depending on a speed, an engine load and/or an exhaust gas volumetric flow of the internal combustion engine 100. The control device 60 may, to this end, be connected to the actuator 44 via a corresponding signal line (dashed line). In principle, the actuator 44 can be controlled independently of the control of the exhaust gas conduit 30. Preferably, the air flow through the bypass line 40 is set in this case in a manner adapted to the setting of the exhaust gas conduit 30. By way of example, the control device 60 may be designed to close the actuator 44 when the shut-off element 32 of the exhaust gas conduit 30 is open, and to unblock it when the shut-off element 32 of the exhaust gas conduit 30 is closed.

FIG. 2 shows a compressor characteristic diagram of a compressor 14 according to one embodiment. The compressor characteristic diagram describes the operating behaviour of the compressor 12, wherein this is a double-flow compressor in the present case. The pressure ratio in an arbitrary unit is plotted on the vertical (Y) axis. The performance level in an arbitrary unit is plotted on the horizontal (X) axis. In the compressor characteristic diagram, the surge line 80 in the form of a line for the respectively minimum performance level and a compressor characteristic curve 82 for a compressor speed are drawn. The operating point 72 indicates an example of a nominal output point for the compressor 12. If the two flows of the compressor 12 are acted upon, this generates only very little output at low performance levels (cf. operating point 74). By blocking one of the two flows and acting upon only one of the two flows with the all the exhaust gas, it is possible to markedly increase the output of the turbine 12 and thus of the compressor 14 even at low speeds or performance levels, cf. operating point 76. However, the risk arises here of the operating point lying above the surge line 80, although this can be circumvented by the provision of a corresponding bypass line 40, such that, ultimately, a stable operating point, cf. operating point 78, can be ensured.

Although the invention has been described with reference to particular exemplary embodiments, it will be apparent to those skilled in the art that various modifications can be made and equivalents can be used as a replacement without departing from the scope of the invention. Consequently, the invention is not intended to be limited to the disclosed exemplary embodiments, but is intended to encompass all exemplary embodiments that fall within the scope of the appended claims. In particular, the invention also claims protection for the subject matter and the features of the dependent claims independently of the referenced claims.

List of reference signs

| | |
|---|---|
| 2 | Cylinder |
| 10 | Turbocharger device |
| 12 | Turbine |
| 12a | First flow |
| 12b | Second flow |
| 14 | Compressor |
| 20 | Exhaust gas manifold |
| 30 | Exhaust gas conduit |
| 32 | Shut-off element |
| 34 | Further shut-off element |
| 40 | Bypass line |
| 40a | Bypass inlet |
| 40b | Bypass outlet |
| 42 | Non-return element |
| 44 | Actuator |
| 60 | Control device |
| 72, 74 76 | Operating points |
| 80 | Surge line |
| 82 | Compressor characteristic curve |
| 100 | Internal combustion engine |

1-15. (canceled)

16. An internal combustion engine having:
a turbocharger device, which has a turbine and a compressor operatively coupled to the turbine, wherein the turbine has a first flow and a second flow;
an exhaust gas manifold which fluidically connects together the first flow and the second flow with a plurality of cylinders of the internal combustion engine;
an exhaust gas conduit, by means of which a first exhaust gas stream through the first flow is settable independently of a second exhaust gas stream through the second flow,
a bypass line via which the air compressed by the compressor is able to be fed to the turbine bypassing the plurality of cylinders as a result, to realize a stable operating point of the turbocharger device below a surge line of the turbocharger device.

17. The internal combustion engine according to claim 16, wherein:
the internal combustion engine is for a watercraft; and/or
the exhaust gas manifold is a single-flow exhaust gas manifold; and/or
by means of the exhaust gas conduit, only the first exhaust gas stream is able to be throttled or blocked in order to increase a flow rate of the second exhaust gas stream and thus an output of the turbocharger device; and/or
the bypass line is able to be shut off; and/or
the bypass line via which the air compressed by the compressor is able to be fed to the first flow; and/or
the bypass line bypasses the plurality of cylinders in order; and/or
each of the plurality of cylinders is fluidically connected both to the first flow and to the second flow via the exhaust gas manifold; and/or
the exhaust gas manifold is designed to combine exhaust gases from all of the plurality of cylinders and to feed the combined exhaust gases to the first and second flow.

18. The internal combustion engine according to claim 16, wherein:
the exhaust gas conduit has a shut-off element for throttling and/or blocking the first exhaust gas stream.

19. The internal combustion engine according to claim 18, wherein:
the exhaust gas conduit does not have any further shut-off elements and/or the second exhaust gas stream is not able to be throttled or blocked by means of a further shut-off element; or
the exhaust gas conduit has a further shut-off element for throttling and/or blocking the second exhaust gas stream, wherein the shut-off element and the further shut-off element are able to be actuated independently of one another.

20. The internal combustion engine according to claim 18, wherein:
the shut-off element has a flap, a side, and/or a valve; and/or
the shut-off element is arranged in the first flow or upstream of the first flow directly at an inlet of the first flow.

21. The internal combustion engine according to claim 16, wherein the bypass line:
has a bypass inlet which is fluidically connected to the compressor or to a charge air line, arranged upstream of the compressor, of the internal combustion engine; and/or
has a bypass outlet which is fluidically connected to the first flow or to a portion of the exhaust gas manifold that is associated with the first flow.

22. The internal combustion engine according to claim 16, wherein:
the bypass line has a bypass inlet which is fluidically connected to a region of a charge air line between the compressor and an intercooler of the internal combustion engine; and/or
the bypass line has a bypass outlet which is fluidically connected, downstream of the exhaust gas conduit, to the first flow or to a portion of the exhaust gas manifold that is associated with the first flow; and/or
the bypass line is arranged so as to introduce air compressed by the compressor only into the first exhaust gas stream; and/or
the bypass line is arranged so as to feed air compressed by the compressor to the turbine downstream of the exhaust gas conduit and upstream of a turbine wheel of the turbine; and/or
air compressed by the compressor is also able to be fed to the first flow via the bypass line when the first exhaust gas stream has been throttled or blocked by means of the exhaust gas conduit.

23. The internal combustion engine according to claim 16, wherein:
air is able to flow through the bypass line only in the direction of the turbine and/or the bypass line has a non-return element.

24. The internal combustion engine according to claim 16, wherein the non-return element is a non-return valve and/or a check valve.

25. The internal combustion engine according to claim 16, wherein the bypass line:
has an actuator by means of which an air flow through the bypass line is able to be set.

26. The internal combustion engine according to claim 25, also having:
a control device which is designed to control the exhaust gas conduit to set the first exhaust gas stream.

27. The internal combustion engine according to claim 26 wherein:
the control device is designed, when a predetermined trigger condition exists to control the exhaust gas conduit in such a way that the first exhaust gas stream through the first flow is throttled or blocked.

28. The internal combustion engine according to claim 27, wherein:
the actuator is a control and/or regulating valve; and/or
the control device is designed to control the exhaust gas conduit to throttle or block the first exhaust gas stream depending on a speed, an engine load and/or an exhaust gas volumetric flow of the internal combustion engine; and/or
the control device is also designed to control the actuator to set the air flow through the bypass line.

29. The internal combustion engine according to claim 28, wherein:
the control device is designed, when a predetermined trigger condition exists such that a speed of the internal combustion engine drops below a speed boundary value of 1200 rpm, to control the exhaust gas conduit in such a way that the first exhaust gas stream through the first flow is throttled or blocked, such that, the second exhaust gas stream through the second flow is increased; and, when the predetermined trigger condition no longer exists, to control the exhaust gas conduit in such a way that the first exhaust gas stream through the first flow is not throttled or blocked; and/or
the control device is also designed to control the actuator to set the air flow through the bypass line in a manner adapted to the exhaust gas conduit, depending on a speed, an engine load and/or an exhaust gas volumetric flow of the internal combustion engine.

30. The internal combustion engine according to claim 16, wherein:
the turbine is a double-flow turbine and/or has no further flows apart from the first and second flow; and/or
the exhaust gas manifold is a single-flow exhaust gas manifold and/or fluidically connects all the cylinders of the internal combustion engine both to the first flow and to the second flow; and/or
the internal combustion engine has an intercooler for cooling the air compressed by the compressor.

31. A watercraft having an internal combustion engine according to claim 16.

32. The watercraft according to claim 31, wherein the watercraft is a ship.

33. A motor vehicle having an internal combustion engine according to claim 16.

34. The motor vehicle according to claim 33, wherein the motor vehicle is a commercial vehicle.

35. A method for operating an internal combustion engine according to claim 16, wherein the method comprises:
combining exhaust gas from a plurality of cylinders of the internal combustion engine by means of an exhaust gas manifold;
feeding the combined exhaust gases via the exhaust gas manifold to a first flow and to a second flow of a turbine of a turbocharger device of the internal combustion engine, wherein one part of the combined exhaust gases flows as a first exhaust gas stream through the first flow and another part of the combined exhaust gases flows as a second exhaust gas stream through the second flow;
setting the first exhaust gas stream through the first flow by means of an exhaust gas conduit independently of the second exhaust gas stream through the second flow; and
feeding air compressed by means of a compressor of the turbocharger device to the turbine via a bypass line, bypassing the plurality of cylinders as a result, to realize a stable operating point of the turbocharger device below a surge line of the turbocharger device.

36. The method of claim 35 wherein:
the combining of the exhaust gas is by means of a single-flow exhaust gas manifold; and/or
the setting is a throttling or blocking of the first exhaust gas stream through the first flow by means of the exhaust gas conduit independently of the second exhaust gas stream through the second flow, such that, as a result, a flow rate of the second exhaust gas stream and thus an output of the turbocharger device is increased; and/or
the feeding of the air compressed by means of the compressor of the turbocharger device is to the first flow via the bypass line, bypassing the plurality of cylinders in order.
